(19) United States
(12) Patent Application Publication
(10) Pub. No.: US 2023/0133495 A1
(43) Pub. Date: May 4, 2023

(54) HIGHLY DURABLE LITHIUM SECONDARY BATTERY

(71) Applicant: 3DOM Alliance INC., Tokyo (JP)

(72) Inventors: Ryohei TSUDA, Yokohama (JP); Takeharu FUKUZAWA, Sagamihara (JP); Nobuaki HAMANAKA, Tokyo (JP)

(21) Appl. No.: 17/961,006

(22) Filed: Oct. 6, 2022

(30) Foreign Application Priority Data
Nov. 1, 2021 (JP) 2021-178583

(51) Int. Cl. H01M 10/0568; H01M 10/0525; H01M 50/414; H01M 50/46

(52) U.S. Cl. CPC H01M 10/0568; H01M 10/0525; H01M 50/414; H01M 50/46

(57) ABSTRACT

A lithium secondary battery includes a positive electrode, a negative electrode, an electrolyte, and a separator. The electrolyte contains a lithium salt of an anion represented by Formula (1) and a lithium cation and an organic salt of an anion represented by Formula (1) and a cation represented by Formula (2).

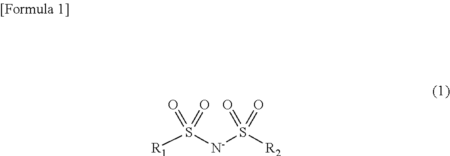

(R₁ and R₂ are the same or different, and are selected from the group consisting of a fluorine atom and fluorinated alkyl groups having 1 to 4 carbon atoms)

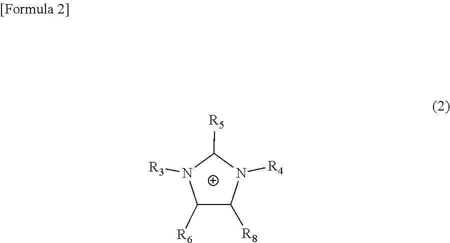

(R₃ and R₄ are the same or different, and are selected from the group consisting of alkyl groups having 1 to 8 carbon atoms; R₅, R₆, and R₇ are the same or different, and are selected from the group consisting of a hydrogen atom and alkyl groups having 1 to 4 carbon atoms; and at least one of R₅, R₆, and R₇ is a hydrogen atom)

### CROSS-REFERENCE TO RELATED APPLICATIONS

This application claims priority to Japanese Patent Application No. 2021-178583 filed Nov. 1, 2021. The entire contents of that application are incorporated by reference herein in their entirety.

### BACKGROUND

### 1. Technical Field

The present invention relates to a novel lithium secondary battery. More specifically, the present invention relates to a lithium secondary battery comprising an electrolyte that contains a lithium salt of a particular anion and a lithium cation and an organic salt of a particular anion and a particular cation.

### 2. Description of the Background

In recent years, portable cordless products such as cell phones, notebook personal computers, and video cameras have been increasingly downsized for portable applications. From the viewpoint of environmental issues such as air pollution and an increase of carbon dioxide, hybrid electric vehicles and pure electric vehicles have been aggressively developed for practical use. These electronic devices and electric vehicles are intended to comprise secondary batteries having excellent features including high efficiency, high power, high energy density, and lightweight. Secondary batteries having these characteristics have been actively studied and developed, and various secondary batteries including lithium batteries and lithium-ion batteries have been put into practical use.

A conventional nonaqueous electrolytic solution for a lithium secondary battery contains a polar aprotic organic solvent in which a lithium salt is dissolved. Such an organic solvent has a low flash point and thus may ignite or explode due to heat generation when overcharging or short circuit occurs, resulting in insufficient safety. To advance downsizing or weight reduction of electronic devices comprising lithium secondary batteries, it is urgently needed to develop high power/high capacity lithium secondary batteries, and accordingly, the safety of lithium secondary batteries is needed to be improved. In such circumstances, using an ionic liquid has been tried as the nonaqueous electrolytic solution for a lithium secondary battery. An ionic liquid containing a bis(fluorosulfonyl)imide anion as an anionic component has a relatively low viscosity, a high energy density, and a high voltage and thus has been well studied as a solvent in a nonaqueous electrolytic solution for a lithium secondary battery.

JP 2016-189239A discloses a lithium-ion secondary battery comprising an electrolytic solution that contains an ionic liquid containing an anionic component such as N(C₄F₉SO₂)₂⁻ and a lithium salt and comprising a separator having a porosity of 80% to 98%.

JP 2018-170271 A discloses an electrolytic solution for a lithium-ion secondary battery comprising a lithium imide salt, an ambient temperature molten salt, and a high vapor pressure solvent.

JP 2019-503571 A discloses a separator for a lithium secondary battery comprising, on the surface thereof, a porous resin having one or more polar functional groups selected from the group consisting of —C—F, —C—OOH, and —C—C═O such that the molar ratio of —C—OOH and —C—C═O to —C—F ranges from 0.2:0.8 to 0.8:0.2.

### BRIEF SUMMARY

As described above, using an ionic liquid in an electrolytic solution for a nonaqueous electrolyte secondary battery has been variously tried. JP 2016-189239A is intended to provide a lithium-ion secondary battery that comprises, in the electrolytic solution, an ionic liquid having a higher viscosity than those of conventionally used carbonate solvents but is excellent in large current characteristics by improving the porosity of a separator or a positive electrode mixture. JP 2018-170271 is intended to improve the initial capacity of a lithium-ion secondary battery that comprises an ambient temperature molten salt, which is relatively difficult to infiltrate into a nonwoven fabric separator, by adding a particular high vapor pressure solvent to improve the infiltration of the electrolytic solution into a separator. JP 2019-503571 characteristically uses, in a lithium secondary battery comprising a conventional electrolytic solution containing an organic solvent such as propylene carbonate, a porous resin having one or more polar functional groups selected from the group consisting of —C—F, —C—OOH, and —C—C═O on the surface of the separator to prevent lithium dendrite formation on the negative electrode.

A lithium secondary battery has a cycle life as a characteristic, but the related art using an ionic liquid as the electrolytic solution in a nonaqueous electrolyte secondary battery provides no improvement in cycle life of a secondary battery. When a charge and discharge cycle is repeated, the charging capacity and the discharging capacity of a secondary battery comprising an ionic liquid immediately deteriorate, but there is no related art to solve such a problem.

The inventors of the present invention have studied a combination of an electrolyte and a separator in a secondary battery comprising an ionic liquid to particularly improve the cycle life. The present invention is intended to provide a novel lithium secondary battery having high durability and a long cycle life.

The present invention relates to a lithium secondary battery at least comprising a positive electrode, a negative electrode, an electrolyte, and a separator. The electrolyte at least contains a lithium salt of an anion represented by Formula (1) and a lithium cation and an organic salt of an anion represented by Formula (1) and a cation represented by Formula (2), the total weight of the lithium salt and the organic salt is 72% by weight or more relative to the total weight of the electrolyte, the proportion of the organic salt to the total weight of the lithium salt and the organic salt is 56 to 82% by weight, the separator has a membrane structure containing a polymer resin as a base material, the polymer resin is a copolymer comprising a constitutional unit including a monomer containing a carbonyl group in the molecule, and the abundance of oxygen derived from the carbonyl group in the monomer is 7% by weight or more and 21% by weight or less.

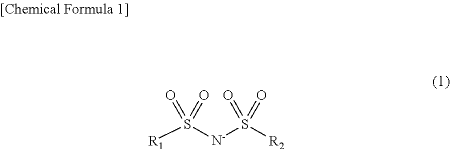

(In Formula (1), R₁ and R₂ are the same or different, and are selected from the group consisting of a fluorine atom and fluorinated alkyl groups having 1 to 4 carbon atoms)

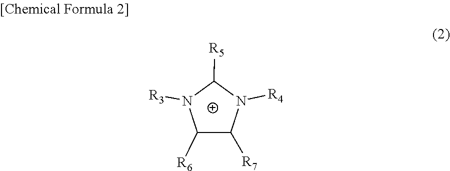

(In Formula (2), R₃ and R₄ are the same or different, and are selected from the group consisting of alkyl groups having 1 to 8 carbon atoms; R₅, R₆, and R₇ are the same or different, and are selected from the group consisting of a hydrogen atom and alkyl groups having 1 to 4 carbon atoms; and at least one of R₅, R₆, and R₇ is a hydrogen atom)

The lithium secondary battery according to the present invention not only has high power and high capacity, but also has excellent durability and a long cycle life.

### DETAILED DESCRIPTION

An embodiment of the present invention is a lithium secondary battery at least comprising a positive electrode, a negative electrode, an electrolyte, and a separator. The electrolyte at least contains a lithium salt of an anion represented by Formula (1) and a lithium cation and an organic salt of an anion represented by Formula (1) and a cation represented by Formula (2); the total weight of the lithium salt and the organic salt is 72% by weight or more relative to the total weight of the electrolyte; the proportion of the organic salt to the total weight of the lithium salt and the organic salt is 56 to 82% by weight; the separator has a membrane structure containing a polymer resin as a base material; the polymer resin is a copolymer comprising a constitutional unit including a monomer containing a carbonyl group in the molecule; and the abundance of oxygen derived from the carbonyl group in the monomer is 7% by weight or more and 21% by weight or less.

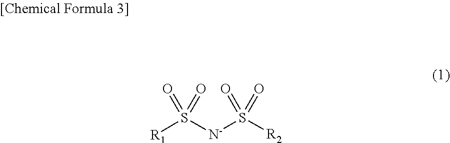

(In Formula (1), R₁ and R₂ are the same or different, and are selected from the group consisting of a fluorine atom and fluorinated alkyl groups having 1 to 4 carbon atoms)

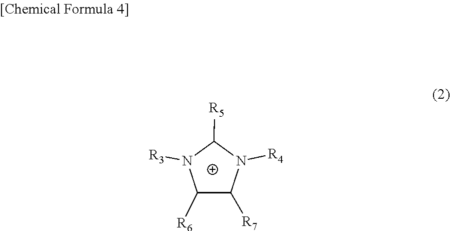

(In Formula (2), R₃ and R₄ are the same or different, and are selected from the group consisting of alkyl groups having 1 to 8 carbon atoms; R₅, R₆, and R₇ are same or different, and are selected from the group consisting of a hydrogen atom and alkyl groups having 1 to 4 carbon atoms; and at least one of R₅, R₆, and R₇ is a hydrogen atom)

The secondary battery in the embodiment is a chemical cell that is reversibly chargeable and dischargeable. In the present description, all the batteries that are reversibly charged and discharged by transferring lithium ions are called lithium secondary batteries. In the present description, the term lithium secondary battery includes both what is called a metal lithium secondary battery comprising metallic lithium as the negative electrode active material described later and a lithium-ion secondary battery comprising a substance that can adsorb and desorb lithium ions as the negative electrode active material.

In the embodiment, the electrodes including the positive electrode and the negative electrode are components of the lithium secondary battery. In discharge of a lithium secondary battery, an electrode having a higher electric potential is the positive electrode, whereas an electrode having a lower electric potential is the negative electrode. In the embodiment, the electrode is prepared by forming an electrode mixture layer containing an electrode active material on the surface of an electrode collector. The electrode collector is typically formed from a metal plate or a metal foil, holds an electrode active material on the surface thereof, and functions to supply current to the electrode active material or to receive current from the electrode active material. The electrode active material is a substance that undergoes chemical reaction to discharge energy and is particularly a substance that can undergo battery reaction in a secondary battery to discharge electric energy to the outside. The electrode mixture layer is prepared by depositing an electrode active material mixture containing, in addition to the above electrode active material, a conductive auxiliary agent and a binder as needed. The electrode mixture layer is where battery reaction proceeds. The conductive auxiliary agent is for assisting electron transfer in an electrode mixture layer. The binder is for bonding the above electrode active material and optionally a conductive auxiliary agent together to form an electrode mixture layer.

In the embodiment, the positive electrode is prepared by forming a positive electrode mixture layer containing a positive electrode active material on the surface of a positive electrode collector. The positive electrode collector is formed from a metal plate or a metal foil, specifically from an aluminum plate or an aluminum foil, holds a positive electrode active material on the surface thereof, and functions to supply current to the positive electrode active material or to receive current from the positive electrode active material. The positive electrode collector preferably has a thickness of 5 μm to 20 μm. The positive electrode active material may be any material but is preferably a metal oxide or a metal sulfide capable of intercalating or deintercalating lithium ions at the time of charging and discharging. Examples of such a metal oxide or a metal sulfide include an oxide of vanadium, a sulfide of vanadium, an oxide of molybdenum, a sulfide of molybdenum, an oxide of manganese, an oxide of chromium, an oxide of titanium, a sulfide of titanium, a composite oxide of them, and a composite sulfide of them. Examples of such a compound include Cr₃O₈, V₂O₅, V₅O₁₈, VO₂, Cr₂O₅, MnO₂, TiO₂, MoV₂O₈, TiS₂V₂S₅MoS₂, MoS₃VS₂, Cr_{0.25}V_{0.75}S₂, and Cr_{0.5}V_{0.5}S₂. In addition, LiMY₂ (M is a transition metal such as Co and Ni; and Y is a chalcogen element such as O and S), LiM₂Y₄ (M is Mn; and Y is O), an oxide such as WO₃, a sulfide such as CuS, Fe_{0.25}V_{0.75}S₂, and Na_{0.1}CrS₂, or a phosphorus-sulfur compound such as NiPS₈ and FePS₈ may also be used. A manganese oxide or a lithium-manganese composite oxide having a spinel structure is also preferred.

As the positive electrode active material, specifically, a lithium composite oxide containing lithium, such as LiCoO₂, LiNiₓCo_{y}Mn_{z}O₂, LiNiₓCo_{y}Al_{z}O₂, Li₆FeO₄, LiMn₂O₄, Li(NiₓMn_{y})₂O₄, LiVOPO₄, and a Li₂MnO₃—LiMO₂ solid solution, may be suitably used.

In the embodiment, the positive electrode mixture layer is prepared by depositing a positive electrode active material mixture containing, in addition to the above positive electrode active material, a conductive auxiliary agent and a binder as needed. The positive electrode mixture layer is where battery reaction (positive electrode reaction) proceeds. The conductive auxiliary agent is for assisting electron transfer in a positive electrode mixture layer. As the conductive auxiliary agent, a carbon material including carbon fibers such as carbon nanofibers, a carbon black such as acetylene black and Ketjen Black, activated carbon, graphite, mesoporous carbon, a fullerene, and carbon nanotubes may be used. The binder is for bonding the above positive electrode active material and optionally a conductive auxiliary agent together to form a positive electrode mixture layer. The binder may be a fluorine resin such as polyvinylidene fluoride (PVDF), polytetrafluoroethylene (PTFE), and polyvinyl fluoride (PVF), an electrically conductive polymer such as a polyaniline, a polythiophene, a polyacetylene, and a polypyrrole, a synthetic rubber such as styrene butadiene rubber (SBR), butadiene rubber (BR), chloroprene rubber (CR), isoprene rubber (IR), and acrylonitrile butadiene rubber (NBR), or a polysaccharide such as carboxymethyl cellulose (CMC), xanthan gum, guar gum, and pectin. In addition, the positive electrode mixture layer may appropriately contain an electrode additive typically used to form an electrode, such as a thickener, a dispersant, and a stabilizer.

The positive electrode may be prepared as follows: a slurry in which a positive electrode mixture containing a positive electrode active material, a conductive auxiliary agent, and a binder is dispersed in an appropriate solvent is applied onto at least one surface of a substantially planar positive electrode collector; and the solvent is evaporated to form a positive electrode mixture layer.

To prepare a metal lithium secondary battery in the present embodiment, the positive electrode active material preferably contains a lithium-nickel composite oxide (called NCM, NMC, or the like) represented by LiₐNiₓM₁₋ₓO₂ (0<a<1.2; 0.45<x<0.95; and M is at least one element selected from Mn, Co, Fe, Zr, and Al). More specifically, a lithium-nickel composite oxide represented by LiNiₓCo_{y}Mn_{1-x-y}O₂ or LiNiₓCo_{y}Al_{1-x-y}O₂ (0.45<x<0.95; 0.01<y<0.55) (called NCA) is preferred.

The content of the positive electrode active material is preferably 85 parts by mass or more and 99.4 parts by mass or less relative to 100 parts by mass of the positive electrode mixture layer. This should allow lithium to be sufficiently intercalated and deintercalated.

The content of the binder is preferably 0.1 part by mass or more and 5.0 parts by mass or less relative to 100 parts by mass of the positive electrode mixture layer. When the content of the binder is within the above range, the coating properties of an electrode slurry, the binding properties of the binder, and the balance of battery characteristics are further improved. When the binder is contained at a content of not more than the above upper limit, an electrode active material is contained at a large content to increase the capacity relative to the electrode mass, and thus such a condition is preferred. When the binder is contained at a content of not less than the above lower limit, electrode separation is suppressed, and thus such a condition is preferred.

The content of the conductive auxiliary agent is preferably 0.1 part by mass or more and 3.0 parts by mass or less relative to 100 parts by mass of the positive electrode mixture layer. When the conductive auxiliary agent is contained at a content of not more than the upper limit, an electrode active material is contained at a large content to increase the capacity relative to the electrode mass, and thus such a condition is preferred. When the conductive auxiliary agent is contained at a content of not less than the lower limit, the electrode has a higher electric conductivity, and thus such a condition is preferred.

The density of the positive electrode mixture layer is not specifically limited but is preferably, for example, 2.0 to 3.6 g/cm³. When the density is within the numerical range, the discharging capacity is improved at the time of use at a high discharge rate, and thus such a condition is preferred.

In the embodiment, the negative electrode is prepared by forming a negative electrode mixture layer containing a negative electrode active material on the surface of a negative electrode collector. The negative electrode collector is formed preferably from a metal plate or a metal foil, specifically from a copper plate or a copper foil, holds a negative electrode active material on the surface thereof, and functions to supply current to the negative electrode active material or to receive current from the negative electrode active material. As the negative electrode collector, copper or a copper alloy on which lithium is scattered or copper or a copper alloy on which another metal species (such as tin and indium) is formed as a film by plating or vapor deposition. The negative electrode collector preferably has a thickness of 5 μm to 20 μm. The negative electrode active material may comprise any substance that can adsorb and desorb lithium ions transferred from the positive electrode, and examples of the material include a carbon material, specifically graphite. Graphite is a carbon material of hexagonal platelet crystals and is also called black lead or plumbago. The graphite is preferably in a particle form. Graphite includes natural graphite and artificial graphite. Natural graphite is available in large amounts at low cost and has a stable structure and excellent durability. Artificial graphite is a graphite artificially produced, has a high purity (almost free from impurities such as an allotrope), and thus has a small electric resistance. As the negative electrode active material in the embodiment, both natural graphite and artificial graphite may be suitably used. A natural graphite coated with amorphous carbon or an artificial graphite coated with amorphous carbon may also be used. Amorphous carbon is a carbon material that may partially have a structure similar to graphite, has a randomly networked structure of fine crystals, and is generally amorphous. Examples of the amorphous carbon include carbon black, coke, activated carbon, carbon fibers, hard carbon, soft carbon, and mesoporous carbon. These negative electrode active materials may be used as a mixture in some cases. A graphite coated with amorphous carbon may also be used.

As the negative electrode active material in the negative electrode in the embodiment, metallic lithium may also be used.

In the embodiment, the negative electrode mixture layer is prepared by depositing a negative electrode active material mixture containing, in addition to the above negative electrode active material, a conductive auxiliary agent and a binder as needed. The negative electrode mixture layer is where battery reaction (negative electrode reaction) proceeds. The conductive auxiliary agent is for assisting electron transfer in a negative electrode mixture layer. As the conductive auxiliary agent, a carbon material including carbon fibers such as carbon nanofibers, a carbon black such as acetylene black and Ketjen Black, activated carbon, graphite, mesoporous carbon, a fullerene, and carbon nanotubes may be used. The binder is for bonding the above negative electrode active material and optionally a conductive auxiliary agent together to form a negative electrode mixture layer. The binder may be a fluorine resin such as polyvinylidene fluoride (PVDF), polytetrafluoroethylene (PTFE), and polyvinyl fluoride (PVF), an electrically conductive polymer such as a polyaniline, a polythiophene, a polyacetylene, and a polypyrrole, a synthetic rubber such as styrene butadiene rubber (SBR), butadiene rubber (BR), chloroprene rubber (CR), isoprene rubber (IR), and acrylonitrile butadiene rubber (NBR), or a polysaccharide such as carboxymethyl cellulose (CMC), xanthan gum, guar gum, and pectin. In addition, the negative electrode mixture layer may appropriately contain an electrode additive typically used to form an electrode, such as a thickener, a dispersant, and a stabilizer.

The negative electrode may be prepared as follows: a slurry in which a negative electrode mixture containing a negative electrode active material, a conductive auxiliary agent, and a binder is dispersed in an appropriate solvent is applied onto at least one surface of a substantially planar negative electrode collector; and the solvent is evaporated to form a negative electrode mixture layer. When metallic lithium is used as the negative electrode active material, a metallic lithium layer may be provided on the surface of a negative electrode collector by a conventionally known method such as sputtering, plating, vapor deposition, and foil adhesion. As the negative electrode active material, a carbon material such as graphite may also be used.

The negative electrode used in the embodiment may be composed of only a negative electrode collector. Being composed of only a negative electrode collector means that a negative electrode collector having no negative electrode mixture layer or the like is directly used. In other words, this means that the negative electrode is an exposed collector at the initial state of the lithium secondary battery in the embodiment.

By applying an electrical voltage to the lithium secondary battery in the embodiment comprising a negative electrode composed of a negative electrode collector before use, lithium derived from the above positive electrode is precipitated on the negative electrode collector to form a negative electrode active material layer. By charging the lithium secondary battery in the embodiment at an initial charging voltage of 4.0 V or more, an appropriate amount of lithium as the negative electrode active material is precipitated on the negative electrode. Using a negative electrode composed of a negative electrode collector as described above eliminates the necessity of direct use of metallic lithium having high reactivity in a production process of a lithium secondary battery, and this can reduce the burning risk during or after production of batteries.

The lithium secondary battery in the embodiment comprises an electrolyte. In the embodiment, the electrolyte at least contains a lithium salt of an anion represented by Formula (1):

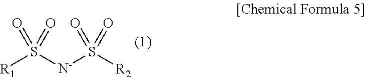

(in Formula (1), R₁ and R₂ are the same or different, and are selected from the group consisting of a fluorine atom and fluorinated alkyl groups having 1 to 4 carbon atoms) and a lithium cation and an organic salt of an anion represented by Formula (1):

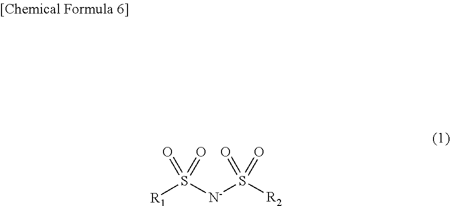

(in Formula (1), R₁ and R₂ are the same or different, and are selected from the group consisting of a fluorine atom and fluorinated alkyl groups having 1 to 4 carbon atoms) and a cation represented by Formula (2):

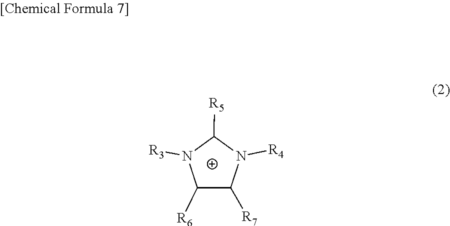

(in Formula (2), R₃ and R₄ are the same or different, and are selected from the group consisting of alkyl groups having 1 to 8 carbon atoms; R₅, R₆, and R₇ are the same or different, and are selected from the group consisting of a hydrogen atom and alkyl groups having 1 to 4 carbon atoms; and at least one of R₅, R₆, and R₇ is a hydrogen atom).

In Formula (1), R₁ and R₂ are the same or different, and are selected from the group consisting of a fluorine atom and fluorinated alkyl groups having 1 to 4 carbon atoms. The anion represented by Formula (1) is preferably at least one anion selected from the group consisting of bis(fluorosulfonyl)imide (FSI), (fluorosulfonyl)(trifluoromethanesulfonyl)imide, and bis(trifluoromethanesulfonyl)imide (TFSI). In other words, in the embodiment, the lithium salt of an anion represented by Formula (1) and a lithium cation is at least one salt selected from the group consisting of lithium bis(fluorosulfonyl)imide, lithium (fluorosulfonyl)(trifluoromethanesulfonyl)imide, and lithium bis(trifluoromethanesulfonyl)imide.

The cation represented by Formula (2) is a cation typically called an imidazolium cation. In the cation represented by Formula (2), R₃ and R₄ are the same or different, and are selected from the group consisting of alkyl groups having 1 to 8 carbon atoms; R₅, R₆, and R₇ are the same or different, and are selected from the group consisting of a hydrogen atom and alkyl groups having 1 to 4 carbon atoms; and at least one of R₅, R₆, and R₇ is a hydrogen atom. At least one of R₅, R₆, and R₇ being a hydrogen atom has the technical meaning described later. The cation represented by Formula (2) is particularly preferably an alkylimidazolium cation in which R₅, R₆, and R₇ are a hydrogen atom. Examples of the cation represented by Formula (2) include a 1-ethyl-3-methylimidazolium cation, a 1-ethyl-3-n-octylimidazolium cation, a 1-hexyl-2,3-dimethylimidazolium cation, a 1-hexyl-3-methylimidazolium cation, a 1-(2-hydroxyethyl)-3-methylimidazolium cation, a 1,3-dimethylimidazolium cation, a 1-butyl-3-methylimidazolium cation, and a 1-butyl-2,3-dimethylimidazolium cation.

In the embodiment, the total weight of the lithium salt and the organic salt is preferably 72% by weight or more relative to the total weight of the electrolyte, and the proportion of the organic salt to the total weight of the lithium salt and the organic salt is preferably 56 to 82% by weight. It has been found that, when the electrolyte in the embodiment satisfies the above proportions, the cycling characteristics of the lithium secondary battery is particularly improved, and the service life of the lithium secondary battery is improved. The electrolyte may contain, in addition to the lithium salt and the organic salt, a solvent for these salts, such as a hydrofluoroether (including 1,1,2,2-tetrafluoroethyl 2,2,2-trifluoroethyl ether), a carbonate, an ether, an ester, a sulfone, a nitrile, a phosphorus compound, a boron compound, a fluorinated aromatic compound, an alkali metal salt, and an alkaline earth metal salt.

The electrolyte in the embodiment contains an organic salt composed of only ions (an anion and a cation) as a main component. The organic salt contained in the electrolyte in the embodiment is preferably a liquid salt typically called an ionic liquid, an ion liquid, or an ambient temperature molten salt. In the present description, such a liquid salt is generally called an ionic liquid. In the present embodiment, two types of salts of a lithium salt and an organic salt (ionic liquid) are preferably used as main components. The anions represented by Formula (1) that is a common component in the two salts of the lithium salt of an anion represented by Formula (1) and a lithium cation and the organic salt of an anion represented by Formula (1) and a cation represented by Formula (2) may be the same or different. The anions represented by Formula (1) that is a common component in the lithium salt and in the organic salt are particularly preferably the same anion.

The lithium secondary battery in the embodiment comprises a separator. A separator is interposed between a positive electrode and a negative electrode and is used for separating the positive electrode and the negative electrode to prevent short circuit, for holding an electrolyte needed for battery reaction to ensure a high ionic conductivity, for preventing a battery reaction inhibitor from passing, and for achieving current interruption characteristics to ensure safety. The separator has a membrane structure containing a polymer resin as a base material. As the membrane structure containing a polymer resin as a base material, a polyolefin film may be used. Polyolefin is a compound prepared by polymerizing or copolymerizing an α-olefin such as ethylene, propylene, butene, pentene, and hexene, and examples include polyethylene, polypropylene, polybutene, polypentene, polyhexene, and copolymers of them. In addition, a polyimide resin, a polyamide resin such as nylon, a polyester resin such as polyethylene terephthalate and polyethylene naphthalate, a polyvinyl chloride resin, a polyvinylidene chloride resin, a polyurethane resin, a polyoxymethylene resin, a fluorine resin such as polytetrafluoroethylene, a polyparaphenylene benzbisthiazole resin, or the like may also be used. A separator containing a resin having a low melting point or a low softening point is likely to be thermally melted to be shrunk when the temperature of a lithium secondary battery increases. Thermal shrinkage of a separator causes short circuit between electrodes, and thus the resin preferably has a high melting point or a high softening point, for example, a melting point or a softening point of not less than 140° C.

When the separator used in the embodiment is a polyolefin film, the polyolefin film preferably has pores that clog when the battery temperature increases, or a porous or microporous polyolefin film is preferred. The separator may be a cross-linked polyolefin film. The separator may have a heat-resistant microparticle layer on one side or each side. Examples of the heat-resistant inorganic microparticles include microparticles of an inorganic oxide such as silica, alumina (α-alumina, β-alumina, θ-alumina), iron oxide, titanium oxide, barium titanate, and zirconium oxide; and microparticles of a mineral such as boehmite, zeolite, apatite, kaolin, spinel, mica, and mullite.

As the separator, a porous resin film in which pores three-dimensionally communicate with each other through communicating holes (in the present description, such a structure is called a “3-DOM structure”) is also preferably used. Using such a separator having the “3-DOM structure” uniformizes the current distribution of lithium ions in a secondary battery (especially in a lithium secondary battery or a lithium-ion secondary battery) and enables safe charge and discharge of the secondary battery without formation of lithium dendrite. Lithium ions are uniformly dispersed, and this uniformizes the ion current density even in diffusion-controlled reaction to uniformly control lithium electrodeposition reaction. By the effect of the 3-DOM structure to uniformize the ion current density, the lithium electrodeposition reaction is uniformly controlled even in a charging and discharging condition at a high current density, and the cycling characteristics of a secondary battery comprising a lithium metal negative electrode can be improved.

The separator having a 3-DOM structure is preferably formed from a polymer resin that is a copolymer comprising a constitutional unit including a monomer containing a carbonyl group in the molecule. The separator having a 3-DOM structure is particularly preferably formed from a polyimide that is a condensate of a polybasic acid or a polybasic acid anhydride and a diamine. In other words, the separator particularly preferably comprises 99 parts by weight or more of a polyimide resin relative to 100 parts by weight of the polymer resin base material. The polybasic acid that is a material monomer of the polyimide resin is preferably a tetrabasic acid. A tetrabasic acid is an acid capable of donating four hydrogen ions per molecule to a base, and examples include a tetracarboxylic acid and a diphthalic acid. The material suitably used for the polyimide resin contained in the separator used in the embodiment is a tetrabasic acid having an aromatic group in the molecule and an anhydride thereof, and examples include benzene-1,2,4,5-tetracarboxylic acid and an anhydride thereof, diphenyl-3,3′,4,4′-tetracarboxylic acid and an anhydride thereof, 4,4′-oxydiphthalic acid and an anhydride thereof, 2,2-bis[4-(3,4-dicarboxyphenoxy)phenyl]propane and a dianhydride thereof, 4,4′-biphthalic acid and an anhydride thereof, and 3,4′-biphthalic acid and an anhydride thereof.

The diamine that is another material monomer of the polyimide resin is a compound having two amino groups in the molecule. The diamine used as the material of the polyimide resin is preferably a diamine having an aromatic group in the molecule, and examples include 1,4-phenylenediamine, 4,4′-diaminodiphenyl ether, 4,4′-diamino-2,2′-dimethylbiphenyl, 3,4-phenylenediamine, 4,4′-isopropylidenebis-[(4-aminophenoxy)benzene], 2,4,6-trimethyl-1,3-phenylenediamine, 4,4′-methylenebis(2-chloroaniline), o-toluidine, 3,4′-diaminodiphenyl ether, 3,4′-diaminodiphenylmethane, and 3,6-diaminocarbazole. A diamine in which two amino groups in the molecule are bonded through an aliphatic group or an alicyclic group, such as 1,4-cyclohexanediamine and 2,2-dimethyl-1,3-propanediamine, may also be used.

The abundance of oxygen derived from a carbonyl group in the whole monomers is preferably 7% by weight or more and 21% by weight or less. In other words, when the separator is formed from a polyimide resin, it is important to select a combination of a tetrabasic acid (or an anhydride thereof) and a diamine such that the abundance of oxygen derived from the carbonyl group contained in the tetrabasic acid (or an anhydride thereof) in the total weight of the material tetrabasic acid (or an anhydride thereof) and the material diamine is 7% by weight or more and 21% by weight or less, preferably 9% by weight or more and 16% by weight or less. For example, in a polyimide resin (the molecular weight of a minimum unit in the polymer: 308.3) prepared by polycondensation of benzene-1,2,4,5-tetracarboxylic acid anhydride (pyromellitic acid anhydride, molecular weight: 218.12) and 1,4-phenylenediamine (molecular weight: 108.14), the abundance of oxygen (four oxygen atoms contained in benzene-1,2,4,5-tetracarboxylic acid anhydride) derived from the carbonyl group in the whole monomers is calculated to be 64.0/308.3=20.8% by weight. Adjusting the abundance of oxygen derived from a carbonyl group in the whole monomers as described above has the following technical meaning: as described above, at least one substituent of R₅, R₆, and R₇ on the imidazolium cation ring represented by Formula (2) contained in an ionic liquid is a hydrogen atom; the hydrogen atom on the imidazolium cation and the carbonyl group in the polyimide resin form a hydrogen bond; the imidazolium cation in the ionic liquid is accordingly stabilized; the stabilized imidazolium cation leads to stabilization of the ionic liquid itself; this suppresses decomposition of the electrolyte due to charging and discharging; and the charge and discharge cycle life is improved.

The polyimide resin separator having a 3-DOM structure can be formed as follows, for example: benzene-1,2,4,5-tetracarboxylic acid anhydride and 4,4′-diaminodiphenyl ether are polycondensed with monodispersed polystyrene beads or the like as a mold; then the prepared polyimide resin film is heated to sublimate the polystyrene beads; and thus voids are generated where the polystyrene beads were present. As a result, a porous (3-DOM structure) polyimide resin film in which pores three-dimensionally communicate with each other through communicating holes can be prepared.

The above positive electrode and the negative electrode are stacked through the separator to form a power generation device. One or more positive electrodes, one or more negative electrodes, and one or more separators may be stacked. To the prepared power generation device, members for extracting current, such as a positive electrode tab and a negative electrode tab, are appropriately attached, and other necessary members are appropriately provided. The power generation device with the members is enclosed in an outer body such as a metal coin cell and an aluminum laminated film, and the electrolyte is poured, yielding the lithium secondary battery in the embodiment. The battery may have any shape including a conventionally known shape such as a laminate shape, a cylinder shape, a square shape, and a coin shape. When the lithium secondary battery is, for example, a coin battery, typically, a negative electrode sheet is placed on a cell floorboard; a separator and an electrolyte are placed thereon; a positive electrode is placed to face the negative electrode; and the whole is swaged with a gasket and a sealing plate to give a lithium secondary battery. When the secondary battery is, for example, a laminated battery, terminals such as a positive electrode tab and a negative electrode tab are attached to electrodes; the electrodes with the terminals are stacked through a separator to form a power generation device; the power generation device is inserted into a bag prepared from a metal laminated film; an electrolyte is poured into the bag; and the laminated film is sealed to give a lithium secondary battery. The structure or the production method of the lithium secondary battery in the embodiment is not limited to them.

In the lithium secondary battery in the embodiment, the positive electrode, the negative electrode, the electrolyte, and the like contained in the battery may be any materials known as those for the positive electrode, the negative electrode, the electrolytic solution in conventional secondary batteries.

### EXAMPLES

The present invention will next be specifically described with reference to Examples, but the present invention is not intended to be limited to them.

### Example 1

<Preparation of Lithium Secondary Battery>

A positive electrode mixture prepared by mixing 98% by weight of a lithium-nickel-manganese-cobalt composite oxide (LiNi_{0.8}Co_{0.1}Mn_{0.1}O₂, hereinafter called NMC811) as a positive electrode active material, 1% by weight of carbon nanotubes as a conductive auxiliary agent, and 1% by weight of polyvinylidene fluoride (PVDF) as a binder was applied at a basis weight of 3.2 mg/cm² onto an aluminum foil having a thickness of 12 μm to prepare a positive electrode. Separately, a copper foil having a thickness of 10 μm and stacked with metallic lithium having a thickness of 20 μm was prepared as a negative electrode. A polyimide resin (a copolymer comprising a constitutional unit including a monomer containing a carbonyl group in the molecule; the abundance of oxygen derived from the carbonyl group in the monomer was 20.8% by weight) prepared by polycondensation of benzene-1,2,4,5-tetracarboxylic acid anhydride (PMDA) and 4,4′-diaminodiphenyl ether (ODA) was used to prepare a polymer resin base material film having a 3-DOM structure (having a total thickness of 20 μm) as a separator. Lithium bis(fluorosulfonyl)imide (LiFSI) was dissolved in 1-ethyl-3-methylimidazolium bis(fluorosulfonyl)imide (EMIFSI) (organic salt) at a concentration of 34% by weight (relative to the total weight of EMIFSI and LiFSI), and the resulting mixed solution was used as an electrolyte. The prepared electrolyte was visually observed at this stage to evaluate the solubility. A substantially uniform electrolyte was evaluated as “good”, whereas an electrolyte in which insoluble substances were observed was evaluated as “poor”.

The metallic lithium used as the negative electrode active material may be an appropriate commercial product. NMC811 used as the positive electrode active material may be a commercial product of Beijing Easpring Material Technology, Umicore, or the like; PVDF used as the binder may be a commercial product of KUREHA, Solvay, Arkema, or the like; the carbon nanotubes used as the conductive auxiliary agent may be a commercial product of Nano C or the like; EMIFSI used as the electrolyte may be a commercial product of Kishida Chemical, Tokyo Chemical Industry, or the like; and LiFSI used as the electrolyte may be a commercial product of Nippon Shokubai, Kishida Chemical, Tokyo Chemical Industry, or the like.

The above positive electrode (4.0×3.0 cm), the separator (4.5×3.5 cm), and the negative electrode (4.2×3.2 cm) were stacked to prepare a power generation device, and a positive electrode tab and a negative electrode tab were attached to the power generation device. The power generation device with the tabs together with the above electrolyte in a volume twice the total pore volume (unit: mL) of the positive electrode and the separator was integrated into an outer body of an aluminum laminated film (thickness: 110 μm), and the periphery of the outer body was sealed to give a laminated cell (secondary battery) having a cell capacity of 40 mAh.

<Cycling Characteristics of Secondary Battery>

[Initial Charge and Discharge]

The laminated cell produced as above was subjected to initial charge and discharge. In the initial charge and discharge, constant current-constant voltage (CC-CV) charge was performed at an atmospheric temperature of 25° C., at a current rate of 0.1 C, at a voltage upper limit of 4.3 V, and at a cutoff of 0.03 C, and then constant current (CC) discharge was performed to 2.8 V at a current rate of 0.1 C.

[Charge and Discharge from Second Cycle]

The laminated cell after the above initial charge and discharge was subjected to charge and discharge cycles. As for the cycle conditions, constant current-constant voltage (CC-CV) charge in an environment at a temperature of 25° C., at a charge current rate of 0.2 C, at a voltage upper limit of 4.3 V, and a cutoff of 0.03 C and constant current (CC) discharge at a discharge current rate of 0.5 C and a voltage lower limit of 2.8 V were regarded as one cycle, and such charge and discharge were repeated 100 cycles (100 times).

The charging capacities and the discharging capacities of the initial charge and discharge and the charge and discharge from the second cycle were calculated as a specific capacity per mass of NMC811 in the positive electrode. The ratio of the cell capacity after the 100th cycle of charge and discharge to the cell capacity after the initial charge and discharge was calculated as the cell capacity retention ratio.

### Examples 2 to 8

The mixing ratio of EMIFSI and LiFSI in Example 1 was changed to prepare a mixed solution, and a laminated cell was produced in a similar manner to Example 1 (Examples 2 to 8). In a similar manner to Example 1, the cycling characteristics of each cell were determined, and the cell capacity retention ratio was calculated.

### Comparative Examples 1 to 3

Substantially the same procedure as in Example 1 was performed except that the concentration of LiFSI in Example 1 was changed to 8% by weight, giving a cell (Comparative Example 1). Substantially the same procedure as in Example 1 was performed except that the concentration of LiFSI in Example 1 was changed to 46%, giving a laminated cell (Comparative Example 2). In a similar manner to Example 1, the cycling characteristics of each cell were determined, and the cell capacity retention ratio was calculated.

Substantially the same procedure as in Example 1 was performed except that an ionic liquid prepared by dissolving LiFSI in 1-methyl-1-propylpyrrolidinium bis(fluorosulfonyl)imide (MPPYFSI) at a concentration of 36% by weight was used as the electrolyte, giving a laminated cell (Comparative Example 3). In a similar manner to Example 1, the cycling characteristics of the cell were determined, and the cell capacity retention ratio was calculated.

MPPYFSI may be an appropriate commercial product of Kishida Chemical, Tokyo Chemical Industry, or the like.

### Example 9

Substantially the same procedure as in Example 1 was performed except that a liquid prepared by mixing 81% by weight of the mixed solution of EMIFSI and LiFSI prepared in Example 1 and 19% by weight of 1,1,2,2-tetrafluoroethyl 2,2,3,3-tetrafluoropropyl ether was used, giving a laminated cell. In a similar manner to Example 1, the cycling characteristics of the cell were determined, and the cell capacity retention ratio was calculated.

1,1,2,2-Tetrafluoroethyl 2,2,3,3-tetrafluoropropyl ether may be an appropriate commercial product of FUJIFILM Wako Pure Chemical, Tokyo Chemical Industry, or the like.

### Example 10

Substantially the same procedure as in Example 9 was performed except that a liquid prepared by mixing 72% by weight of the mixed solution of EMIFSI and LiFSI prepared in Example 9 and 28% by weight of 1,1,2,2-tetrafluoroethyl 2,2,3,3-tetrafluoropropyl ether was used, giving a laminated cell. In a similar manner to Example 9, the cycling characteristics of the cell were determined, and the cell capacity retention ratio was calculated.

### Comparative Examples 4 and 5

Substantially the same procedure as in Example 9 was performed except that a liquid prepared by mixing 62% by weight of the mixed solution of EMIFSI and LiFSI prepared in Example 1 and 38% by weight of 1,1,2,2-tetrafluoroethyl 2,2,3,3-tetrafluoropropyl ether was used, giving a laminated cell. In a similar manner to Example 9, the cycling characteristics of the cell were determined, and the cell capacity retention ratio was calculated (Comparative Example 4).

Substantially the same procedure as in Comparative Example 3 was performed except that a liquid prepared by mixing 80% by weight of the mixed solution of MPPYFSI and LiFSI prepared in Comparative Example 3 and 20% by weight of 1,1,2,2-tetrafluoroethyl 2,2,3,3-tetrafluoropropyl ether was used, giving a laminated cell. In a similar manner to Comparative Example 3, the cycling characteristics of the cell were determined, and the cell capacity retention ratio was calculated (Comparative Example 5).

### Comparative Example 6

Substantially the same procedure as in Example 1 was performed except that a film prepared by coating a biaxially stretched polypropylene (PP) having a thickness of 16 μm with an alumina coating having a thickness of 4 μm was used as the separator, giving a laminated cell. In a similar manner to Example 1, the cycling characteristics of the cell were determined, and the cell capacity retention ratio was calculated.

The biaxially stretched polypropylene separator may be an appropriate commercial product of Asahi Kasei, Toray Industries, or the like.

TABLE 1
Examples

| | | | | | | | | Number |
|---|---|---|---|---|---|---|---|---|
| | | | | | | | | of cycles |
| | | | | | | | | when |
| | | | | | | | | capacity |
| | | | | | | Additional | | retention |
| | | | | | | component | | ratio of |
| | Organic salt | | Lithium salt | | Electrolyte | in electrolyte | | 95% is |
| | | % by | | % by | solubility | (% by | Separator | achieved |
| | type | weight | type | weight | good/poor | weight) | type | times |
| Example 1 | EMIFSI | 66 | LiFSI | 34 | good | | PMDA/ODA | >200 |
| Example 2 | EMIFSI | 82 | LiFSI | 18 | good | | PMDA/ODA | 134 |
| Example 3 | EMIFSI | 76 | LiFSI | 24 | good | | PMDA/ODA | 146 |
| Example 4 | EMIFSI | 70 | LiFSI | 30 | good | | PMDA/ODA | 195 |
| Example 5 | EMIFSI | 63 | LiFSI | 37 | good | | PMDA/ODA | >200 |
| Example 6 | EMIFSI | 61 | LiFSI | 39 | good | | PMDA/ODA | >200 |
| Example 7 | EMIFSI | 58 | LiFSI | 42 | good | | PMDA/ODA | 188 |
| Example 8 | EMIFSI | 56 | LiFSI | 44 | good (after | | PMDA/ODA | 167 |
| | | | | | heating) | | | |
| Example 9 | EMIFSI | 53.5 | LiFSI | 27.5 | good | HFE (19) | PMDA/ODA | 174 |
| Example 10 | EMIFSI | 47.5 | LiFSI | 24.5 | good | HFE (28) | PMDA/ODA | 138 |

TABLE 2
Comparative Example

| | | | | | | | | Number |
|---|---|---|---|---|---|---|---|---|
| | | | | | | | | of cycles |
| | | | | | | | | when |
| | | | | | | | | capacity |
| | | | | | | Additional | | retention |
| | | | | | | component | | ratio of |
| | Organic salt | | Lithium salt | | Electrolyte | in electrolyte | | 95% is |
| | | % by | | % by | solubility | (% by | Separator | achieved |
| | type | weight | type | weight | good/poor | weight) | type | times |
| Comparative | EMIFSI | 92 | LIFSI | 8 | good | | PMDA/ODA | 89 |
| Example 1 | | | | | | | | |
| Comparative | EMIFSI | 54 | LIFSI | 46 | poor | | PMDA/ODA | (unmeasurable) |
| Example 2 | | | | | | | | |
| Comparative | MPPYFSI | 64 | LIFSI | 36 | good | | PMDA/ODA | (insufficient charge |
| Example 3 | | | | | | | | and discharge) |
| Comparative | EMIFSI | 40.9 | LIFSI | 21.1 | poor | HFE (38) | PMDA/ODA | (unmeasurable) |
| Example 4 | | | | | | | | |
| Comparative | MPPYFSI | 52.8 | LIFSI | 27.2 | good | HFE (20) | PMDA/ODA | 47 |
| Example 5 | | | | | | | | |
| Comparative | EMIFSI | 64 | LIFSI | 36 | good | | PP/alumina | (electrolyte failing |
| Example 6 | | | | | | | | to infiltrate into |
| | | | | | | | | separator) |

The battery capacity of each lithium secondary battery in Examples of the present invention did not greatly deteriorate by charge and discharge cycles. In particular, the lithium secondary batteries in Examples 1, 5, and 6 maintained 95% of the initial battery capacity even after charge and discharge were repeated 200 times. Each electrolyte used in the lithium secondary batteries in Examples had good solubility, and no insoluble component was observed.

In contrast, the electrolyte used in the lithium secondary battery in Comparative Example 1 contained a relatively small amount of the lithium salt. The battery capacity of the lithium secondary battery in Comparative Example 1 deteriorated early by charge and discharge cycles. The electrolyte used in the lithium secondary battery in Comparative Example 2 contained a relatively large amount of the lithium salt, and insoluble components were observed. The organic salt in the electrolyte used in the lithium secondary battery in Comparative Example 3 was not the salt of the present invention of an anion represented by Formula (1) and a cation represented by Formula (2). The lithium secondary battery in Comparative Example 3 failed to perform satisfactory charge and discharge. The electrolyte used in the lithium secondary battery in Comparative Example 4 contained a large amount of a hydrofluoroether, and thus a uniform electrolyte was not prepared. The organic salt in the electrolyte used in the lithium secondary battery in Comparative Example 5 was not the salt of the present invention of an anion represented by Formula (1) and a cation represented by Formula (2). The battery capacity of the lithium secondary battery in Comparative Example 5 immediately deteriorated by charge and discharge cycles. In the lithium secondary battery in Comparative Example 6, the electrolyte did not appropriately infiltrate into the separator, and normal charge and discharge were difficult.

The lithium secondary battery of the present invention comprises an electrolyte containing a particular lithium salt and a particular organic salt and a particular separator in combination, and thus the capacity is unlikely to deteriorate by charge and discharge cycles to result in a long service life.

What is claimed is:

1. A lithium secondary battery at least comprising:
a positive electrode;
a negative electrode;
an electrolyte; and
a separator, wherein
the electrolyte at least contains a lithium salt of an anion represented by Formula (1) and a lithium cation and an organic salt of an anion represented by Formula (1) and a cation represented by Formula (2),
a total weight of the lithium salt and the organic salt is 72% by weight or more relative to a total weight of the electrolyte,
a proportion of the organic salt to the total weight of the lithium salt and the organic salt is 56 to 82% by weight,
the separator has a membrane structure containing a polymer resin as a base material,
the polymer resin is a copolymer comprising a constitutional unit including a monomer containing a carbonyl group in a molecule,
an abundance of oxygen derived from the carbonyl group in the monomer is 7% by weight or more and 21% by weight or less: 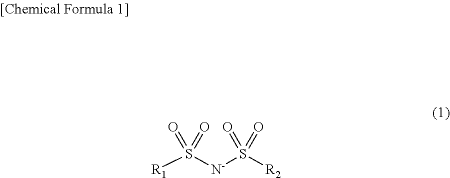
(in Formula (1), R₁ and R₂ are the same or different, and are selected from the group consisting of a fluorine atom and fluorinated alkyl groups having 1 to 4 carbon atoms) 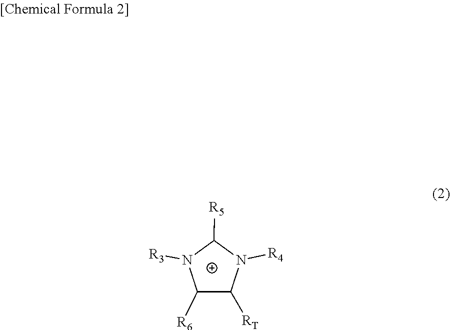
(in Formula (2), R₃ and R₄ are the same or different, and are selected from the group consisting of alkyl groups having 1 to 8 carbon atoms; R₅, R₆, and R₇ are the same or different, and are selected from the group consisting of a hydrogen atom and alkyl groups having 1 to 4 carbon atoms; and at least one of R₅, R₆, and R₇ is a hydrogen atom).

2. The lithium secondary battery according to claim 1, wherein the anion represented by Formula (1) is at least one anion selected from the group consisting of bis(fluorosulfonyl)imide, (fluorosulfonyl)(trifluoromethanesulfonyl)imide, and bis(trifluoromethanesulfonyl)imide.

3. The lithium secondary battery according to claim 1, wherein the cation represented by Formula (2) in the organic salt is an alkylimidazolium cation in which R₅, R₆, and R₇ are a hydrogen atom.

4. The lithium secondary battery according to claim 2, wherein the cation represented by Formula (2) in the organic salt is an alkylimidazolium cation in which R₅, R₆, and R₇ are a hydrogen atom.

5. The lithium secondary battery according to claim 1, wherein the anion represented by Formula (1) in the lithium salt is identical with the anion represented by Formula (1) in the organic salt.

6. The lithium secondary battery according to claim 2, wherein the anion represented by Formula (1) in the lithium salt is identical with the anion represented by Formula (1) in the organic salt.

7. The lithium secondary battery according to claim 3, wherein the anion represented by Formula (1) in the lithium salt is identical with the anion represented by Formula (1) in the organic salt.

8. The lithium secondary battery according to claim 4, wherein the anion represented by Formula (1) in the lithium salt is identical with the anion represented by Formula (1) in the organic salt.

9. The lithium secondary battery according to claim 1, wherein the separator contains 99 parts by weight or more of a polyimide resin relative to 100 parts by weight of the base material.

10. The lithium secondary battery according to claim 2, wherein the separator contains 99 parts by weight or more of a polyimide resin relative to 100 parts by weight of the base material.

11. The lithium secondary battery according to claim 3, wherein the separator contains 99 parts by weight or more of a polyimide resin relative to 100 parts by weight of the base material.

12. The lithium secondary battery according to claim 4, wherein the separator contains 99 parts by weight or more of a polyimide resin relative to 100 parts by weight of the base material.

13. The lithium secondary battery according to claim 5, wherein the separator contains 99 parts by weight or more of a polyimide resin relative to 100 parts by weight of the base material.

14. The lithium secondary battery according to claim 6, wherein the separator contains 99 parts by weight or more of a polyimide resin relative to 100 parts by weight of the base material.

15. The lithium secondary battery according to claim 7, wherein the separator contains 99 parts by weight or more of a polyimide resin relative to 100 parts by weight of the base material.

16. The lithium secondary battery according to claim 8, wherein the separator contains 99 parts by weight or more of a polyimide resin relative to 100 parts by weight of the base material.
